(19) United States
(12) Patent Application Publication
(10) Pub. No.: US 2017/0342692 A1
(43) Pub. Date: Nov. 30, 2017

(54) Spray head

(71) Applicant: Globe Union Industrial Corp., Taichung City (TW)

(72) Inventor: Shengping HU, Shen Zen (CN)

(21) Appl. No.: 15/164,695

(22) Filed: May 25, 2016

(51) Int. Cl. E03C 1/084; B05B 1/14; B05B 1/30; E03C 1/04

(52) U.S. Cl. CPC E03C 1/084; E03C 1/0412; B05B 1/14; B05B 1/3026; E03C 2001/0415

(57) ABSTRACT

A spray head contains: a shell and a waterway which includes a body, a side plate, and a spray face. The side plate covers on the body so as to define a first conduit, a second conduit, and a third conduit among which a water-diverting valve chamber is defined and accommodates a water-diverting valve, a button is connected with the water-diverting valve, a spring is fixed between the water-diverting valve and the water-diverting valve chamber, an aerator is mounted on the spray face which includes multiple spray nozzles. The body further includes a first cliff, a first fence, a first cavity, a first space, multiple first grooves, and multiple second grooves. The spray face includes a panel, a second cliff, and a second fence which has multiple locking tabs, wherein the second cliff has a second cavity, between the second cliff and the second fence is defined a trench.

### FIELD OF THE INVENTION

The present invention relates to a spray head, and more particularly to a switching spray head which is applicable for a kitchen or bathroom.

### BACKGROUND OF THE INVENTION

A conventional faucet wand, spray head, or pull-out spray is adapted for a kitchen or a bathroom. For example, a faucet wand is disclosed in U.S. Pat. No. 7,854,401 B2 and is switched to different water supply modes (such as stream or spray) by pressing a button.

The faucet wand contains a shell and a waterway defined in the shell. The waterway contains a body, a side plate covered on one side of the body so as to define a first conduit, a second conduit, and a third conduit. The body includes a water-diverting valve chamber by which the first conduit, the second conduit, and the third conduit are communicated with one another, wherein a water-diverting valve is fixed in the water-diverting valve chamber, and a button is in connection with the water-diverting valve, a spring is defined between the water-diverting valve and the water-diverting valve chamber, such that the button is pressed to drive the water-diverting valve, for example, the first conduit is in communication with the second conduit so as to produce stream or the first conduit communicates with the third conduit so as to produce spray.

The body also includes a spray face screwed with a head portion thereof, and the spray face has an aerator secured on a central position thereof and communicating with the second conduit, such that water flows through the aerator from the second conduit so as to form stream. The aerator has a plurality of spray nozzles arranged around a peripheral side thereof so that the water flows through the plurality of spray nozzles from the second conduit so as to produce the spray. Between the body and the spray face are defined two leak-proof rings so as to avoid water leakage out of the aerator, the plurality of spray nozzles or the spray face.

However, the spray face is screwed with the body, so the spray face and the body collide with each other to reduce their service lives. In addition, the spray face is loose, so the water leaks out of the two leak-proof rings, the aerator or the plurality of spray nozzles. The spray face is screwed with the body troublesomely.

The aerator is positioned on the central position of the spray face, before assembling the spray face, accordingly when removing the aerator, the spray face is removed firstly and the two leak-proof rings are replaced or cleaned inconveniently.

The present invention has arisen to mitigate and/or obviate the afore-described disadvantages.

### SUMMARY OF THE INVENTION

The primary objective of the present invention is to provide a spray head in which the spray face and the body are connected together firmly.

Further objective of the present invention is to provide a spray head in which the spray face and the body are removed easily and quickly.

Another objective of the present invention is to provide a spray head in which the aerator is replaced or is cleaned quickly without removing the spray face so as to prevent water leakage.

To obtain the above objective, a spray head provided by the present invention contains: a shell and a waterway defined in the shell.

The waterway includes a body, a side plate covered on one side of the body, and a spray face connected with an outlet segment of the body. The side plate covers on the one side of the body so as to define a first conduit, a second conduit, and a third conduit. Among the first conduit, the second conduit, and the third conduit of the body is defined a water-diverting valve chamber, such that the first conduit, the second conduit, and the third conduit communicate with one another via the water-diverting valve chamber, a water-diverting valve is disposed in the water-diverting valve chamber, a button is in connection with the water-diverting valve, and a spring is fixed between the water-diverting valve and the water-diverting valve chamber, such that the button is pressed to drive the water-diverting valve, and the first conduit is in communication with the third conduit so as to produce stream or the first conduit is in communication with the third conduit so as to produce spray. An aerator is mounted on the spray face so that water flows through the aerator from the third conduit, thus producing the stream. The spray face includes a plurality of spray nozzles arranged thereon so as to flow out of the water from the third conduit, thus producing the spray.

The body further includes a first cliff formed on the outlet segment, a first fence arranged around the first cliff in which a first cavity is defined so as to communicate with the third conduit, a first space defined in the first fence, multiple first grooves formed on an inner wall of the first space, and a plurality of second grooves adjacent to the multiple first grooves, respectively.

The spray face includes a panel, a second cliff extending from a top of the panel, and a second fence arranged around the second cliff; wherein the second cliff has a second cavity defined therein so as to communicate with the first cavity, and the aerator is screwed upwardly into the second cavity from a bottom of the panel; between the second cliff and the second fence is defined a trench so as to communicate with the third conduit; the plurality of spray nozzles are arranged on the panel relative to the trench; the second fence has a plurality of locking tabs extending outwardly from an outer wall thereof, such that the plurality of locking tabs retain into the multiple first grooves of the body and rotatably lock in the plurality of second grooves, individually.

Preferably, the body includes four first grooves formed isometrically on the inner wall of the first space of the body, and the spray face includes four locking tabs isometrically arranged on the second fence.

Preferably, each of the plurality of locking tabs has a guiding segment and a tilted face formed on the guiding segment relative to a bottom of each of the plurality of second grooves, such that said each locking tab retains in said each second groove by using the tilted face.

Preferably, each of the plurality of second grooves has a check recess formed on a bottom thereof, such that each of the plurality of locking tabs retains in the check recess.

Preferably, the second cliff of the spray face has a first leak-proof ring fitted on an outer wall thereof so as to tightly contact with an inner wall of the first cliff; the second fence of the spray face has a second leak-proof ring fitted on an outer wall thereof so as to tightly contact with an inner wall of the second cliff.

Preferably, the first cavity of the body has a threaded orifice defined on a central position of a bottom thereof; the second cavity of the spray face has a through orifice formed on a central position of a bottom thereof, such that a screw bolt screws with the threaded orifice; the second cavity of the spray face also has multiple apertures arranged on the bottom of the second cavity around the through orifice, such that the second cavity is in communication with the first cavity.

### BRIEF DESCRIPTION OF THE DRAWINGS

FIG. 1 is a perspective view showing the assembly of a spray head according to a first embodiment of the present invention.

FIG. 2 is a cross sectional view showing the assembly of the spray head according to the first embodiment of the present invention.

FIG. 3 is an amplified cross sectional view showing the assembly of a part of the spray head according to the first embodiment of the present invention.

FIG. 4 is a perspective view showing the exploded components of a part of the spray head according to the first embodiment of the present invention.

FIG. 5 is a cross sectional view showing the assembly of a part of the spray head according to the first embodiment of the present invention.

FIG. 6 is a side plan view showing the assembly of a spray face of the spray head according to the first embodiment of the present invention.

FIG. 7 is a cross sectional view showing the assembly of a part of a spray head according to a second embodiment of the present invention.

FIG. 8 is a cross sectional view showing the assembly and the operation of a part of the spray head according to the second embodiment of the present invention.

FIG. 9 is a cross sectional view showing the assembly of a part of a spray head according to a third embodiment of the present invention.

### DETAILED DESCRIPTION OF THE PREFERRED EMBODIMENTS

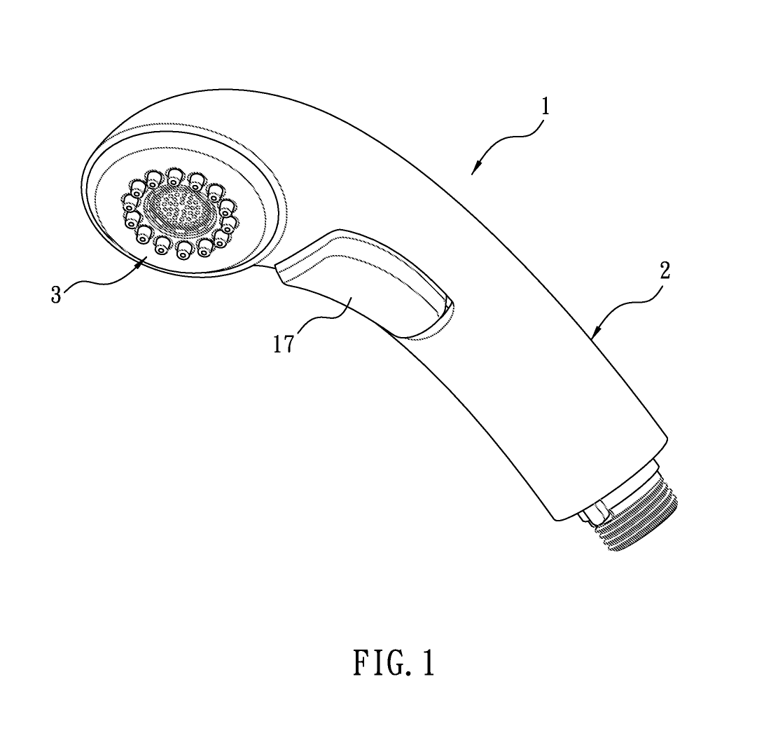

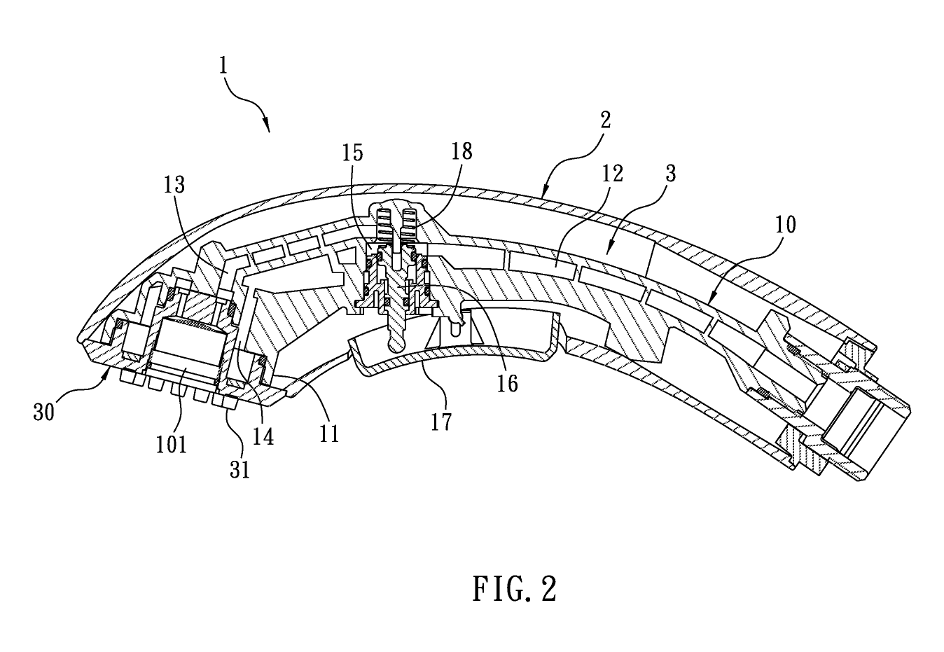

With reference to FIGS. 1-4, a spray head 1 according to a first embodiment of the present invention comprises: a shell 2 and a waterway 3 defined in the shell 1. The waterway 3 includes a body 10, a side plate 20 covered on one side of the body 10, and a spray face 30 connected with an outlet segment 11 of the body 10; wherein the side plate 20 covers on the one side of the body 10 so as to define a first conduit 12, a second conduit 13, and a third conduit 14. Among the first conduit 12, the second conduit 13, and the third conduit 14 of the body 10 is defined a water-diverting valve chamber 15, such that the first conduit 12, the second conduit 13, and the third conduit 14 communicate with one another via the water-diverting valve chamber 15. Furthermore, a water-diverting valve 16 is disposed in the water-diverting valve chamber 15, a button 17 is in connection with the water-diverting valve 16, and a spring 18 is fixed between the water-diverting valve 16 and the water-diverting valve chamber 15, such that the button 17 is pressed to drive the water-diverting valve 16, and the first conduit 12 is in communication with the third conduit 13 so as to produce stream or the first conduit 12 is in communication with the third conduit 14 so as to produce spray. An aerator 101 is mounted on the spray face 30 so that water flows through the aerator 101 from the third conduit 13, thus producing the stream. The spray face 30 includes a plurality of spray nozzles 31 arranged thereon so as to flow out of the water from the third conduit 14, thus producing the spray.

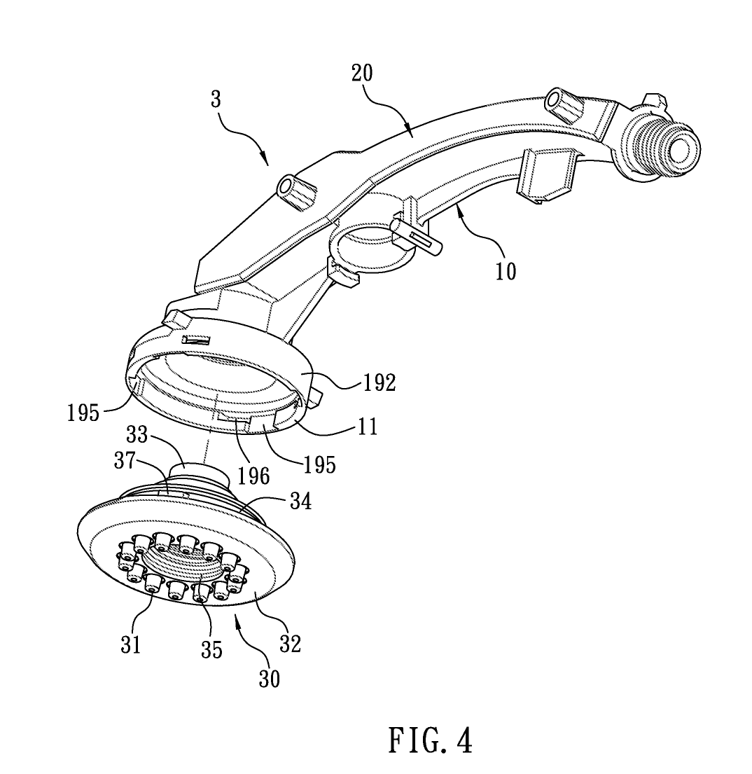

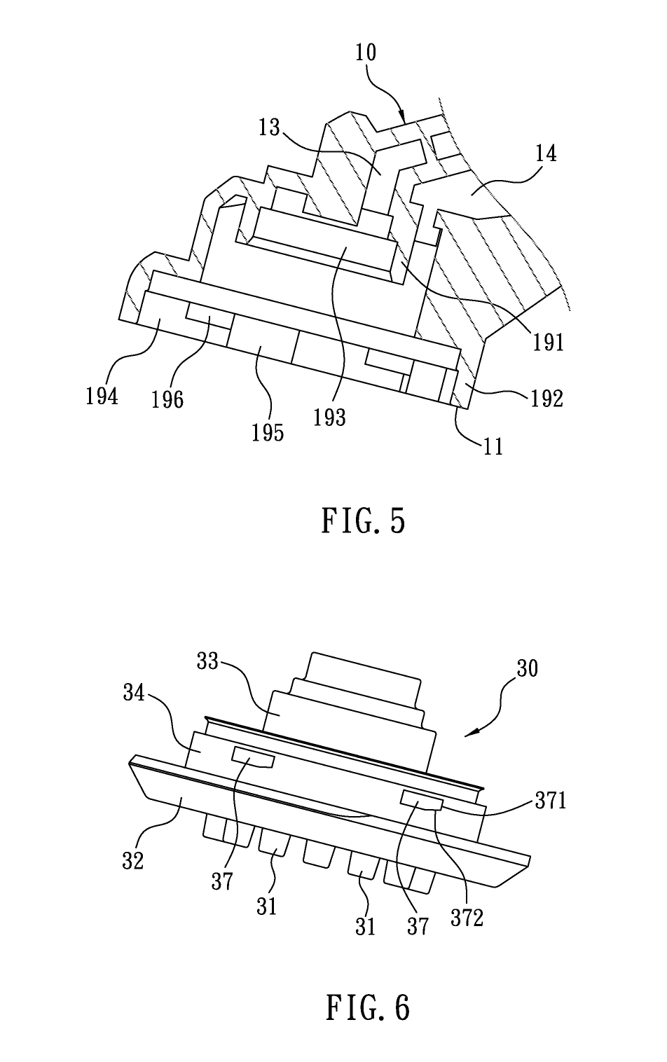

Referring further to FIGS. 4 to 6, the body 10 further includes a first cliff 191 formed on the outlet segment 11, a first fence 192 arranged around the first cliff 191 in which a first cavity 193 is defined so as to communicate with the third conduit 13, a first space 194 defined in the first fence 192, multiple first grooves 195 formed on an inner wall of the first space 194, and a plurality of second grooves 196 adjacent to the multiple first grooves 195, respectively.

The spray face 30 includes a panel 32, a second cliff 33 extending from a top of the panel 32, and a second fence 34 arranged around the second cliff 33; wherein the second cliff 33 has a second cavity 35 defined therein so as to communicate with the first cavity 193, and the aerator 101 is screwed upwardly into the second cavity 35 from a bottom of the panel 32; between the second cliff 33 and the second fence 34 is defined a trench 36 so as to communicate with the third conduit 14; the plurality of spray nozzles 31 are arranged on the panel 32 relative to the trench 36; the second fence 34 has a plurality of locking tabs 37 extending outwardly from an outer wall thereof, such that the plurality of locking tabs 37 retain into the multiple first grooves 195 of the body 10 and rotatably lock in the plurality of second grooves 196, individually.

In this embodiment, the body 10 includes four first grooves 195 formed isometrically on the inner wall of the first space 194 of the body 10, and the spray face 30 includes four locking tabs 37 isometrically arranged on the second fence 34.

Preferably, each of the plurality of locking tabs 37 has a guiding segment 371 and a tilted face 372 formed on the guiding segment 371 relative to a bottom of each of the plurality of second grooves 196, such that said each locking tab 37 retains in said each second groove 196 by using the tilted face 372 easily and securely.

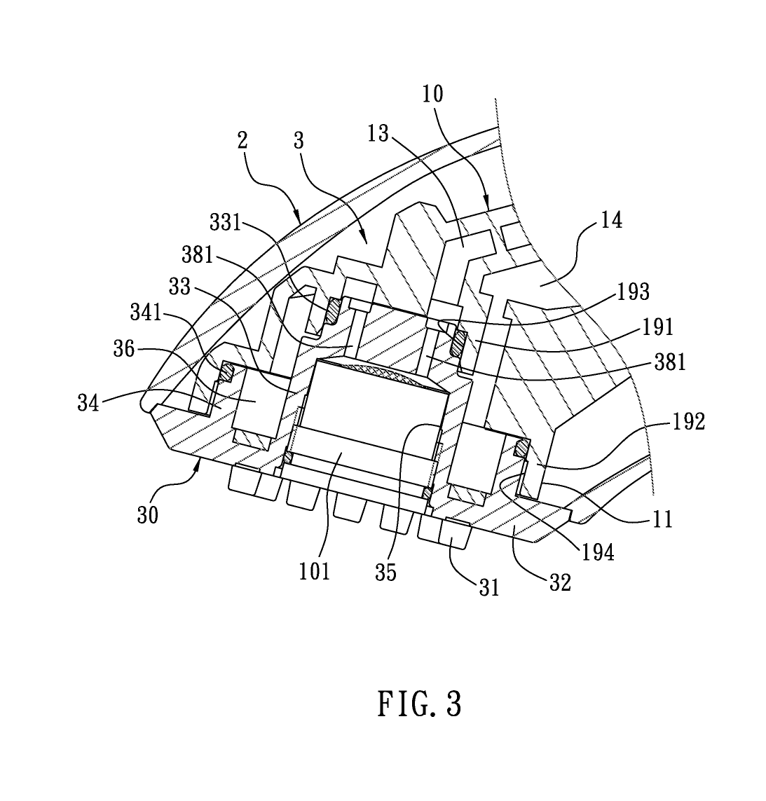

As shown in FIG. 3, the second cliff 33 of the spray face 30 has a first leak-proof ring 311 fitted on an outer wall thereof so as to tightly contact with an inner wall of the first cliff 191; the second fence 34 of the spray face 30 has a second leak-proof ring 341 fitted on an outer wall thereof so as to tightly contact with an inner wall of the second cliff 192.

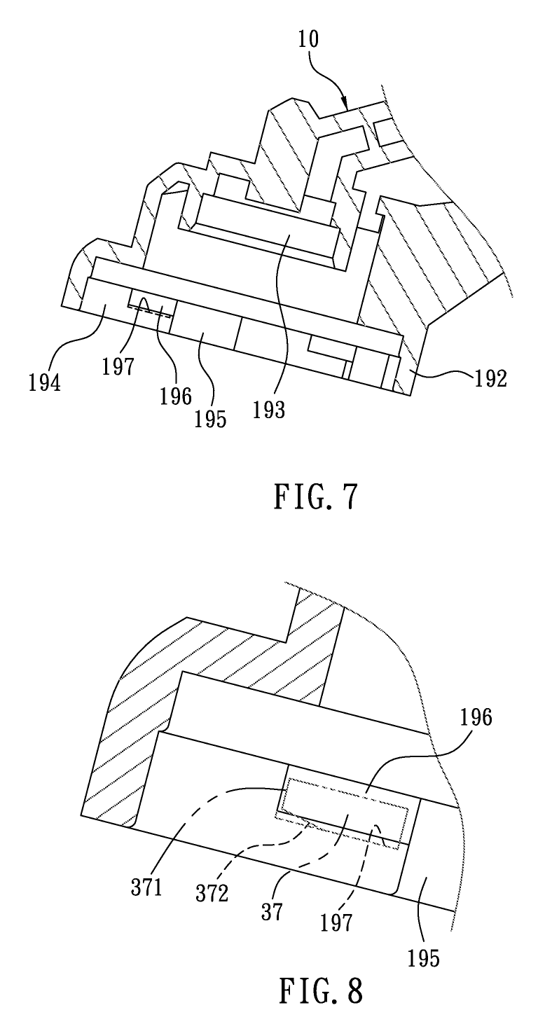

As illustrated in FIGS. 7 and 8, a difference of a spray head 1 of a second embodiment comprises:

a plurality of check recesses 197, each of the plurality of check recesses 197 being formed on a bottom of each of a plurality of second grooves 196, such that each of a plurality of locking tabs 37 retains in said each check recess 197. In other words, said each locking tab 37 of the spray face 30 is rotated into said each second groove 196 and retains in said each check recess 197 fixedly. As desiring to remove the spray face 30 from the body 10, the spray face 30 is pushed upwardly so that said each locking tab 37 removes from said each check recess 197, and the spray face 30 is reversely rotated so that said each locking tab 37 removes from said each second groove 196, and the spray face 30 is pulled downwardly or outwardly so that said each locking tab 37 slides out of each of the multiple first grooves 195, thus removing the spray face 30 from the body 10.

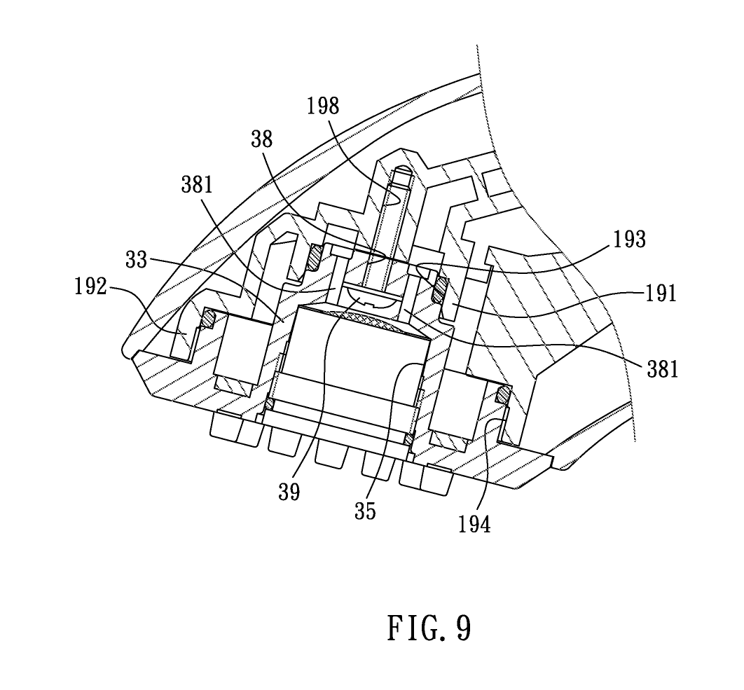

As illustrated in FIG. 9, a difference of a spray head 1 of a third embodiment comprises:

a threaded orifice 198 defined on a central position of a bottom of a first cavity 193 of a body 10; a through orifice 38 formed on a central position of a bottom of the second cavity 35 of a spray face 30, such that a screw bolt 39 screws with the threaded orifice 198, thus connecting the spray face 30 and the body 10 firmly. The second cavity 35 of the spray face 30 has multiple apertures 381 arranged on the bottom of the second cavity 35 around the through orifice 38, such that the second cavity 35 is in communication with the first cavity 193.

Thereby, said each first groove 195 and said each second groove 196 of the body 10 mate with said each locking tab 37 of the spray face 30, thus connecting the spray face 30 with the body 10 easily and securely.

Preferably, said each locking tab 37 retains in said each check recess 197 of said each second groove 196 tightly so as to obtain leak-proof effect.

The aerator 101 is screwed into or is removed from the spray face 30 easily and quickly.

Because the spray face 30 is not removed from the spray head 1, the first leak-proof ring 331 and the second leak-proof ring 341 are not disassembled, thus prolonging service life of the first leak-proof ring 331 and the second leak-proof ring 341.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A spray head comprising: a shell and a waterway defined in the shell; the waterway including a body, a side plate covered on one side of the body, and a spray face connected with an outlet segment of the body; the side plate covering on the one side of the body so as to define a first conduit, a second conduit, and a third conduit; among the first conduit, the second conduit, and the third conduit of the body being defined a water-diverting valve chamber, such that the first conduit, the second conduit, and the third conduit communicate with one another via the water-diverting valve chamber, a water-diverting valve being disposed in the water-diverting valve chamber, a button being in connection with the water-diverting valve, and a spring being fixed between the water-diverting valve and the water-diverting valve chamber, such that the button is pressed to drive the water-diverting valve, and the first conduit is in communication with the third conduit so as to produce stream or the first conduit is in communication with the third conduit so as to produce spray; an aerator being mounted on the spray face so that water flows through the aerator from the third conduit, thus producing the stream; the spray face including a plurality of spray nozzles arranged thereon so as to flow out of the water from the third conduit, thus producing the spray;
wherein the body further includes a first cliff formed on the outlet segment, a first fence arranged around the first cliff in which a first cavity is defined so as to communicate with the third conduit, a first space defined in the first fence, multiple first grooves formed on an inner wall of the first space, and a plurality of second grooves adjacent to the multiple first grooves, respectively;
wherein the spray face includes a panel, a second cliff extending from a top of the panel, and a second fence arranged around the second cliff; wherein the second cliff has a second cavity defined therein so as to communicate with the first cavity, and the aerator is screwed upwardly into the second cavity from a bottom of the panel; between the second cliff and the second fence is defined a trench so as to communicate with the third conduit; the plurality of spray nozzles are arranged on the panel relative to the trench; the second fence has a plurality of locking tabs extending outwardly from an outer wall thereof, such that the plurality of locking tabs retain into the multiple first grooves of the body and rotatably lock in the plurality of second grooves, individually.

2. The spray head as claimed in claim 1, wherein the body includes four first grooves formed isometrically on the inner wall of the first space of the body, and the spray face includes four locking tabs isometrically arranged on the second fence.

3. The spray head as claimed in claim 1, wherein each of the plurality of locking tabs has a guiding segment and a tilted face formed on the guiding segment relative to a bottom of each of the plurality of second grooves, such that said each locking tab retains in said each second groove by using the tilted face.

4. (canceled)

5. The spray head as claimed in claim 1, wherein the second cliff of the spray face has a first leak-proof ring fitted on an outer wall thereof so as to tightly contact with an inner wall of the first cliff; the second fence of the spray face has a second leak-proof ring fitted on an outer wall thereof so as to tightly contact with an inner wall of the second cliff.

6. (canceled)
